(19) United States
(12) Patent Application Publication
(10) Pub. No.: US 2005/0135342 A1
(43) Pub. Date: Jun. 23, 2005

(54) Call waiting service method and apparatus in VoIP terminal with PSTN backup function

(76) Inventor: Cheol-Beom Kim, Suwon-si (KR)

Correspondence Address: Robert E. Bushnell, Suite 300, 1522 K Street, N.W., Washington, DC, 20005, US

(21) Appl. No.: 11/002,224

(22) Filed: Dec. 3, 2004

(30) Foreign Application Priority Data
Dec. 17, 2003 (KR) 2003-92734

(51) Int. Cl. H04L 12/28; H04L 12/56; H04L 12/66

(52) U.S. Cl. 370/352; 370/401

(57) ABSTRACT

A call waiting service method and apparatus in a voice over Internet Protocol (VoIP) terminal with a public switched telephone network (PSTN) backup function can guarantee at least two VoIP or PSTN calls to a user by providing the second telephone with a waiting tone to inform a user of the second telephone of the fact that a new incoming call is received and setting the third telephone to a waiting call when a VoIP incoming call is received from the third telephone to the second telephone while a VoIP call is performed between the first and second telephones, when a PSTN incoming call is received from the third telephone to the second telephone while a VoIP call is performed between the first and second telephones, and when a VoIP incoming call is received from the third telephone to the second telephone while a PSTN call is performed between the first and second telephones. Consequently, the conventional VoIP terminal with the PSTN backup function separately performs the VoIP call waiting service and the PSTN call waiting service, whereas the VoIP terminal with the PSTN backup function of the present invention incorporates the VoIP and PSTN call waiting services, and thus the PSTN incoming call can be guaranteed while the VoIP call is performed, and the VoIP incoming call can be guaranteed while the PSTN call is performed.

### CLAIM OF PRIORITY

This application makes reference to, incorporates the same herein, and claims all benefits accruing under 35 U.S.C. §119 from an application for CALL-WAITING SERVICE METHOD AND APPARATUS IN VoIP EQUIPMENT INCLUDING PSTN BACKUP FUNCTION earlier filed in the Korean Intellectual Property Office on Dec. 17, 2003 and there duly assigned Serial No. 2003-92734.

### BACKGROUND OF THE INVENTION

1. Field of the Invention

The present invention generally relates to a call waiting service method and apparatus in a voice over Internet Protocol (VoIP) terminal with a public switched telephone network (PSTN) backup function, and more particularly, to a call waiting service method and apparatus in a VoIP terminal with a PSTN backup function which can guarantee an incoming call from a PSTN when a VoIP call is busy and can guarantee an incoming call from a VoIP when a PSTN call is busy.

2. Description of the Related Art

As the Internet use is generalized thanks to a world wide web (WWW), a use of a voice over Internet protocol (VoIP) telephone which is relatively low in telephone charge is increasing. The VoIP telephone service is performed by converting an analogue voice signal to a packet voice signal by using the Internet instead of a public switched telephone network (PSTN).

The PSTN is a circuit switch network and thus performs static switching, and also provides a fixed bandwidth of 64 Kbps (kilobits per second), thereby guaranteeing a service quality. The Internet is a packet switching network and thus performs dynamic routing and provides a “Best-effort” type service, whereby it is difficult to guarantee a service quality. However, the Internet telephone has advantages in that a long-distance call is possible at a low telephone fee and various services are possible, and thus its use is gradually increasing.

That is, the Internet telephone using the VoIP implements a telephone service by using the II existing network as it is, and thus telephone users can be provided long-distance call and international call service in Internet or Intranet circumstance at a low telephone charge.

The usefulness of the telephone call in Internet circumstance is increased when a telephone call can be performed through the PSTN as well as the Internet.

Meanwhile, due to such advantages of the VoIP telephone, a telephone receiving system (VoIP terminal) that a PSTN telephone can send and receive a VoIP call has been developed.

Currently, the VoIP terminal cannot function as a primary line due to the instability of networks and a problem of the terminal itself.

Therefore, in order to solve the problem, a PSTN interface is added to the VoIP terminal. However, this merely functions to switch to the PSTN interface from the VoIP interface in limited situations, for example, when power is not supplied to the VoIP terminal or a network is disconnected.

Therefore, a call waiting service between the VoIP interface and the PSTN interface is not supported, and thus the VoIP terminal could not provide a user with a guarantee for an incoming call of another interface when the VoIP terminal is busy.

The conventional VoIP terminal with the PSTN backup function leaves an incoming call from the PSTN interface as it is or forcibly sets the PSTN interface to a busy mode not to receive a call when the VoIP call is busy. Also, when the PSTN call is busy, the VoIP interface is processed in the same way.

FIG. 1 is a schematic view illustrating a network connection configuration of a typical VoIP terminal with a PSTN backup function.

As shown in FIG. 1, the VoIP terminal 20 includes an IP (WAN, wide area network) interface (not shown) for a VoIP service to telephones 10 and 11 and a PSTN interface (not shown) for a PSTN backup function to a telephone 12. Here, the IP (WAN) includes at least one of LAN (local area network), HFC (hybrid fiber coax), and xDSL (x-digital subscriber line).

The PSTN interface of the VoIP terminal 20 connects a PSTN telephone line installed in a house or an office to the VoIP terminal.

Hereinafter, a call processing method of the conventional VoIP terminal with the PSTN backup function is explained with reference to FIG. 2.

FIG. 2 is a flow chart illustrating a call processing method of a conventional VoIP terminal with a PSTN backup function.

As shown in FIG. 2, the VoIP terminal 20 monitors an incoming call received through the VoIP interface and an incoming call received through the PSTN interface.

First, call processing for an incoming call received through the PSTN interface or the PSTN line is explained below.

The VoIP terminal 20 monitors the PSTN telephone line to determine whether or not there is the incoming call received through the PSTN telephone line (S101, S102, S103).

If it is determined that the incoming call is received through the PSTN telephone line, the VoIP telephone line is set to a busy mode (S104), and then the incoming call received through the PSTN telephone line is connected to a receiving telephone, so that a voice call is carried out between an originating telephone and the receiving telephone (S105).

Here, the VoIP terminal 20 can be set to ignore the incoming call received through the VoIP telephone line without setting the VoIP telephone line to a busy mode like the step S104.

That is, if the VoIP terminal 20 receives the incoming call through the VoIP telephone line when the PSTN telephone call is busy, the VoIP terminal 20 transmits a busy tone to the originating terminal to inform an originating party of the fact that a receiving party is on the line or ignores the received VoIP incoming call.

As shown in FIG. 2, call processing for the incoming call received through the VoIP interface is explained below.

The VoIP terminal 20 monitors the VoIP telephone line to determine whether or not there is the incoming call received through the VoIP telephone line (S201, S202, S203).

If it is determined that the incoming call is received through the VoIP telephone line, the PSTN telephone line is set to a busy mode (S204), and then the incoming call received through the VoIP telephone line is connected to the receiving telephone, so that a voice call is carried out between the originating telephone and the receiving telephone (S205).

Here, the VoIP terminal 20 can be set to ignore an incoming call received through the PSTN telephone line without setting the PSTN telephone line to a busy mode like the step S204.

That is, if the PSTN telephone receives an incoming call through the PSTN telephone line when the VoIP telephone line is busy, the PSTN telephone transmits a busy tone to the originating terminal to inform an originating party of the fact that a receiving party is on the line or ignores the received PSTN incoming call.

However, the call processing method of the conventional VoIP terminal with the PSTN backup function has disadvantages in that if an incoming call of the other interface is ignored or left as it is when the call is busy the originating party would not know that the receiving party is on the line and thus has to wait for a call response.

Also, if the PSTN interface is set to a busy mode for long time when the VoIP call is busy, the PSTN exchange can cause an abnormal operation in switching a PSTN call.

### SUMMARY OF THE INVENTION

It is, therefore, an object of the present invention to provide a method and apparatus for a call waiting service in a voice over Internet Protocol (VoIP) terminal with a public switched telephone network (PSTN) backup function which can guarantee an incoming call from a PSTN when a VoIP call is busy and can guarantee an incoming call from a VoIP when a PSTN call is busy.

It is another object of the present invention to provide the call waiting service method and apparatus in the VoIP terminal with the PSTN backup function that can guarantee at least two VoIP or PSTN calls to a user by providing the second telephone with a waiting tone to inform a user of the second telephone of the fact that a new incoming call is received and setting the third telephone to a waiting call when a VoIP incoming call is received from the third telephone to the second telephone while a VoIP call is performed between the first and second telephones, when a PSTN incoming call is received from the third telephone to the second telephone while a VoIP call is performed between the first and second telephones, and when a VoIP incoming call is received from the third telephone to the second telephone while a PSTN call is performed between the first and second telephones.

It is another object of the present invention to provide the VoIP terminal with the PSTN II backup function that incorporates the VoIP and PSTN call waiting services that is easy to implement, cost effective and efficient.

According to an aspect of the present invention, the present invention provides a call switching service method between terminals through a network, including: when an incoming call is received from a third terminal to a second terminal through a first network or a second network while a call is performed between a first terminal and the second terminal through the first network, providing the second terminal with a waiting call generating signal and setting the incoming call originated from the third terminal to a waiting call; and when a waiting call switching signal is received from the second terminal which is busy, switching the first terminal which is busy to a waiting call, and connecting a call between the second terminal and the third terminal which is set to the waiting call.

After the incoming call from the third terminal is set to the waiting call, the call switching service method further includes setting the first and second network interfaces to a busy mode.

The first and second networks include at least one of an IP network and a PSTN.

The waiting call generating signal includes at least one of a tone signal and a waiting call generating voice message, and the waiting call switching signal received from the second terminal is a hook flash signal of the second terminal.

At the step of setting the incoming call from the third telephone to the waiting call, when incoming calls are received from a plurality of terminals through the first or second network, the call switching service method further includes, conferring a priority order to the incoming calls from the terminals according to a received time of the incoming calls and setting the sequential incoming calls of the terminals to the waiting calls.

In the state that the incoming call from the third terminal is set to a waiting call, the call switching service method further includes a) transmitting to the second terminal a call switching request signal for requesting a call to be switched to the third terminal which is currently set to the waiting call when a call connection-terminating signal with the first terminal is received from the second terminal which is busy; and b) connecting a call between the second terminal and the third terminal which is set to the waiting call when a response signal for the call switching request signal is received from the second terminal.

The call connection-terminating signal is a hook on signal, the call switching request signal is a ring signal, and the response signal for the call switching request signal is a hook off signal.

According to another aspect of the present invention, the present invention provides a call switching service method of a VoIP terminal with a PSTN backup function, including: when a VoIP or PSTN incoming call is received from a third telephone to a second telephone while a VoIP call is performed between a first telephone and the second telephone, providing the second telephone with a VoIP or PSTN waiting call generating signal and setting the incoming call from the third telephone to a waiting call; after the incoming call from the third telephone is set to the waiting call, setting a VoIP line and a PSTN line which are connected to the VoIP terminal to a busy mode; and when a hook flash signal is received from the second telephone which is busy, switching the first telephone which is busy to a waiting call, and connecting a VoIP or PSTN call between the second telephone and the third telephone which is set to the waiting call.

At the step of setting the incoming call from the third telephone to the waiting call, when the PSTN or VoIP incoming call is received from at least one telephone, a priority order is conferred to the incoming calls from the telephones according to a received time of the incoming calls before the sequential incoming calls of the telephones are set to the waiting calls.

The call switching service method further includes: in the state that the incoming call from the third telephone is set to the waiting call, when a hook on signal is received from the second telephone which is busy, terminating a call connection with the first telephone and transmitting to the second telephone a ring signal for requesting a VoIP call to be switched to the third telephone which is currently set to the waiting call; and when a hook off signal is received from the second telephone, connecting a call between the second telephone and the third telephone which is set to the waiting call.

According to yet another aspect of the present invention, the present invention provides a call switching service method of a VoIP terminal with a PSTN backup function, including: when a VoIP incoming call is received from a third telephone to a second telephone while a PSTN call is performed between a first telephone and the second telephone, providing the second telephone with a VoIP waiting call generating signal and setting the VoIP incoming call from the third telephone to a waiting call; after setting the incoming call from the third telephone to the waiting call, setting a VoIP line and a PSTN line which are connected to the VoIP terminal to a busy mode; and when a hook flash signal is received from the second telephone which is busy, switching the first telephone which is busy to a waiting call, and connecting a VoIP call between the second telephone and the third telephone which is set to the waiting call.

According to yet another aspect of the present invention, the present invention provides a call switching system between terminals through at least one different network, including: a waiting call processor for providing a second terminal with a waiting call generating signal and setting an incoming call originated from a third terminal to a waiting call when the incoming call is received from the third terminal to the second terminal through a first network interface or a second network interface while a call is performed between a first terminal and the second terminal through the first network interface; and a call switching processor for switching the first terminal which is busy to a waiting call, and connecting a call between the second terminal and the third terminal which is set to the waiting call when a waiting call switching signal is received from the second terminal which is busy.

The waiting call processor sets the first and second network interface lines to a busy mode after setting the incoming call from the third terminal to the waiting call.

The first and second networks include at least one of an IP network and a PSTN.

In the state that the incoming call from the third terminal is set to the waiting call, when incoming calls are received from a plurality of terminals through the first network interface or the second network interface, the waiting call processor confers a priority order to the incoming calls according to a received time of the incoming calls and sets the sequential incoming calls to the waiting calls.

In the state that the incoming call from the third terminal is set to a waiting call, the call switching processor: transmits to the second terminal a call switching request signal for requesting a call to be switched to the third terminal which is currently set to the waiting call when a call connection-terminating signal with the first terminal is received from the second terminal which is busy; and connects a call between the second terminal and the third terminal which is set to the waiting call when a response signal for the call switching request signal is received from the second terminal.

According to yet another aspect of the present invention, the present invention provides a call switching service system of a VoIP terminal with a PSTN backup function and having a VoIP line interface and a PSTN line interface, including: a first incoming call processor for providing a second telephone with a VoIP or PSTN waiting call generating signal and setting a VoIP or PSTN incoming call from a third telephone to a waiting call when the VoIP or PSTN incoming call is received from the third telephone to the second telephone through the VoIP line interface or the PSTN line interface while a VoIP or PSTN call is performed between a first telephone and the second telephone; a second incoming call processor for setting the VoIP or PSTN line interface to a busy mode after the first incoming call processor sets the incoming call from the third telephone to a waiting call; and a call switching processor for setting the first telephone which is busy to the waiting call and connecting the VoIP or PSTN call between the second telephone and the third telephone which is set to the waiting call by the first call processor when a hook flash signal is received from the second telephone which is busy.

The present invention can also be realized as computer-executable instructions in computer-readable media.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating a network connection configuration of a typical VoIP terminal with a PSTN backup function;

FIG. 2 is a flow chart illustrating a call processing method of a conventional VoIP terminal with the PSTN backup function;

FIGS. 3a and 3b are views illustrating a call processing connection for a call waiting service when a VoIP incoming call is received from another telephone in the state that a VoIP call is busy in a VoIP terminal with a PSTN backup function according to a first embodiment of the present invention;

FIGS. 4a and 4b are flow charts illustrating a call waiting service method when the VoIP incoming call is received while a VoIP call is performed in a VoIP terminal with a PSTN backup function according to a first embodiment of the present invention;

FIGS. 5a and 5b are views illustrating a call processing connection for a call waiting service when a PSTN incoming call is received from another telephone in the state that a VoIP call is busy in a VoIP terminal with a PSTN backup function according to a second embodiment of the present invention;

FIGS. 6a and 6b are flow charts illustrating a call waiting service method when a VoIP incoming call is received while a VoIP call is performed in a VoIP terminal with a PSTN backup function according to a second embodiment of the present invention;

FIGS. 7a and 7b are views illustrating a call processing connection for a call waiting service when a PSTN call is received while a VoIP call is performed in a VoIP terminal with a PSTN backup function according to a third embodiment of the present invention;

FIGS. 8a and 8b are flow charts illustrating a call waiting service method when a PSTN call is received while a VoIP call is performed in a VoIP terminal with a PSTN backup function according to a third embodiment of the present invention; and

FIG. 9 shows an example of a computer including a computer-readable medium having computer-executable instructions for performing a technique of the present invention.

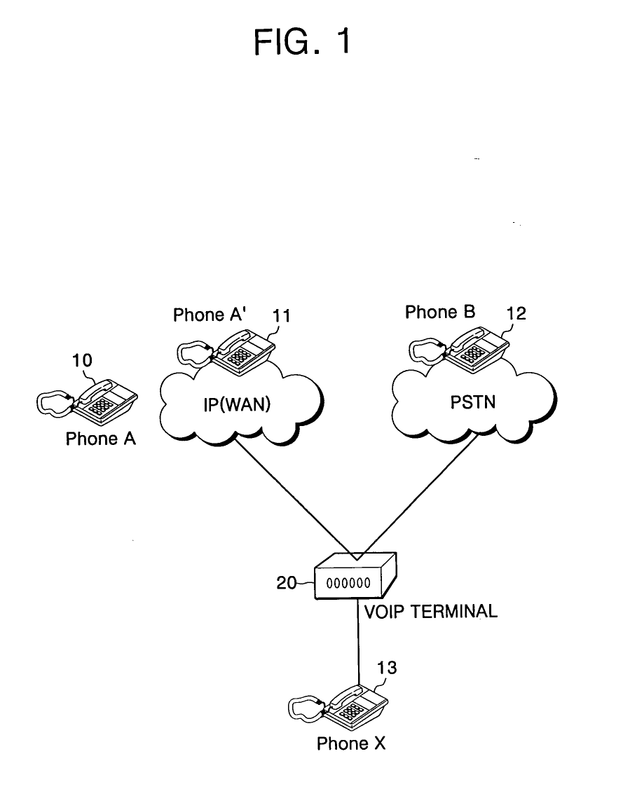

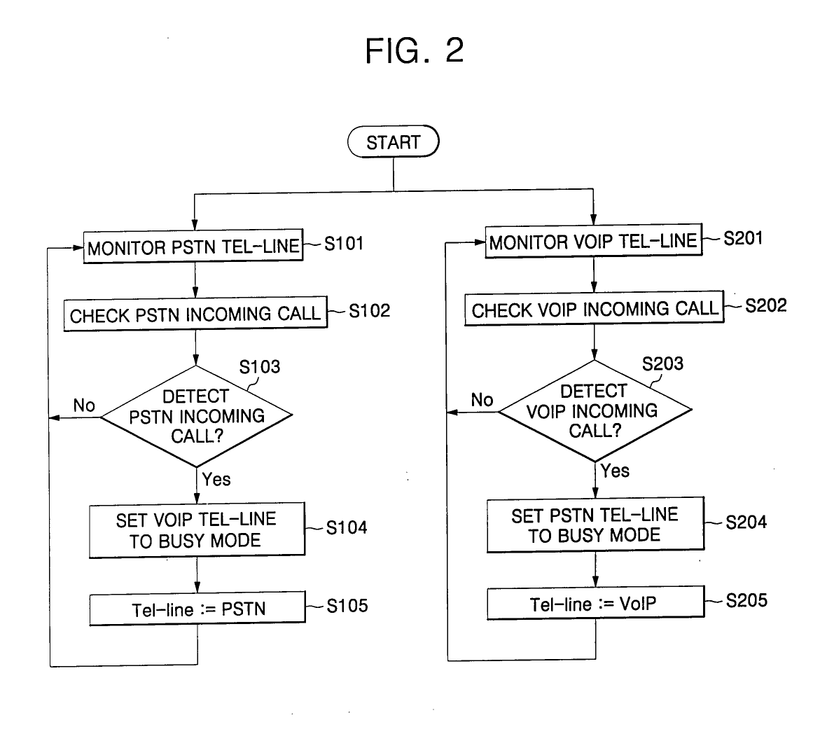

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

### First Embodiment

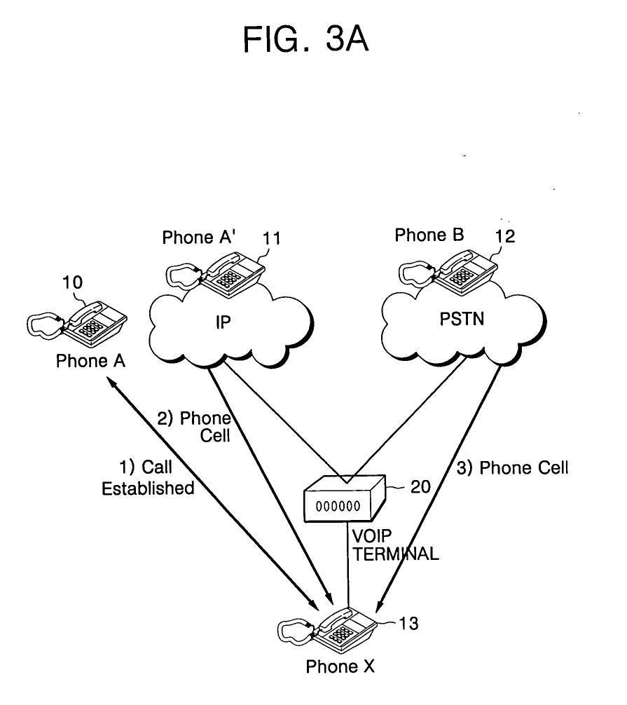

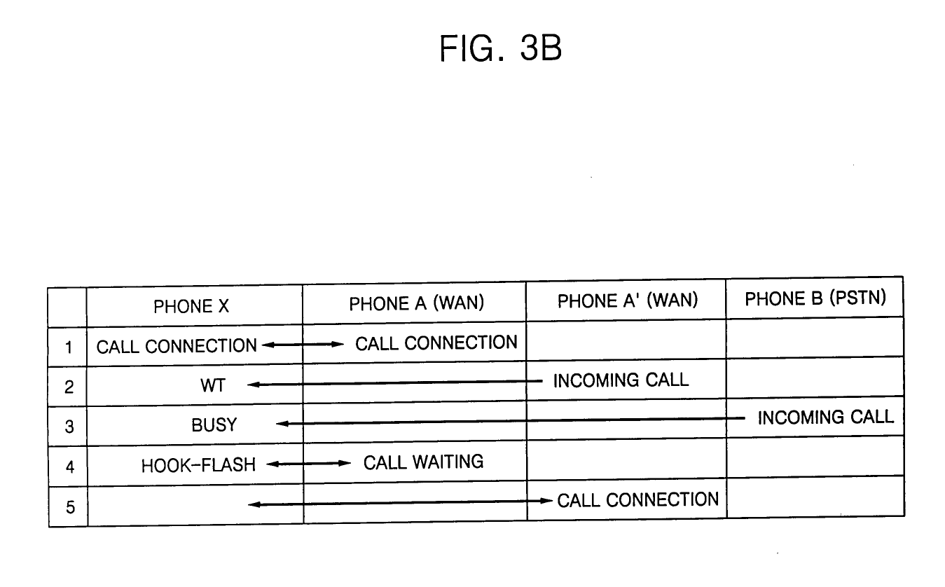

FIG. 3a is a view illustrating a call processing connection for a call waiting service when a VoIP incoming call is received from another telephone in the state that a VoIP call is busy in a VoIP terminal with a PSTN backup function according to a first embodiment of the present invention. FIG. 3b is a chart illustrating a call process for the call waiting service of FIG. 3a.

As shown in FIGS. 3a and 3b, in the state of the VoIP call being busy, that is, a call between a telephone A 10 and a telephone X 13 is connected through a VoIP interface of a VoIP terminal 20, when an incoming call is received from a telephone A′ 11 connected to an IP network to the telephone X 13, the VoIP terminal 20 provides the receiving telephone X 13 which is busy with a waiting tone “wt” for informing that a new VoIP incoming call is received.

In the state that two calls, i.e., a busy call and a waiting call are set, the VoIP terminal 20 sets the VoIP and PSTN lines to a busy mode in order not to receive any more incoming call.

That is, when an incoming call is received from a telephone B 12 through the PSTN line in the state that the busy call and waiting call are set, the VoIP terminal 20 provides the telephone B 12 with a busy tone signal or a busy message to inform a user of the PSTN originating telephone B 12 of the fact that the telephone X 13 is busy.

In this state, if a hook flash signal is generated from the receiving telephone X which is currently busy, the VoIP terminal 20 switches a call with the originating telephone A 10 which is currently performing a VoIP call to a waiting call, and connects a VoIP call between the telephone X 13 and the telephone A′ 11 which is set to the waiting call to thereby perform a voice call therebetween.

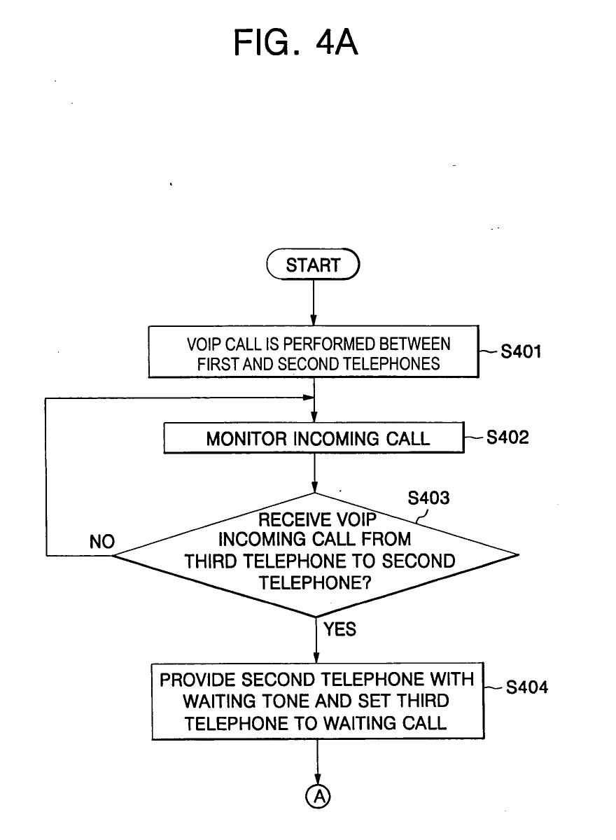

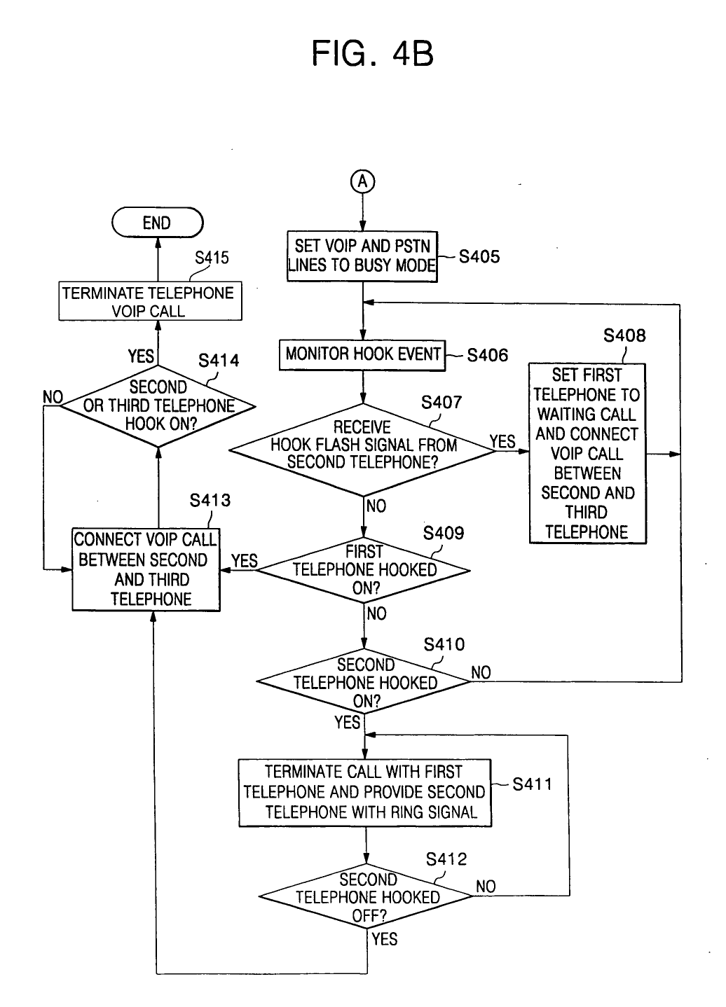

The call waiting service method when the VoIP incoming call is received while a VoIP call is performed according to a first embodiment of the present invention will be explained in more detail with reference to FIGS. 4a and 4b.

FIGS. 4a and 4b are flow charts illustrating a call waiting service method when the VoIP incoming call is received while a VoIP call is performed in a VoIP terminal with a PSTN backup function according to a first embodiment of the present invention.

As shown in FIGS. 4a and 4b, in the state that a VoIP call is performed between the first telephone (originating telephone) and the second telephone (receiving telephone) (S401), the VoIP terminal monitors a new PSTN or VoIP incoming call (S402).

If a VoIP incoming call is received from a third telephone (S403) to the second telephone which is currently busy, the VoIP terminal generates a VoIP waiting tone “wt” to the second telephone to inform a user of the second telephone of the fact that a new VoIP incoming call is received, and sets the new VoIP incoming call from the third telephone to a waiting call (S404).

In the state that two calls, i.e., a busy call and a waiting call, are set, the VoIP terminal sets the VoIP line and the PSTN line to a busy mode (S405).

That is, when an incoming call is received from another telephone in the state that two calls are already set in the VoIP terminal, the VoIP line and the PSTN line are set to a busy mode to provide the corresponding telephone with a busy tone for informing a user of the telephone which generates an incoming call of the fact that the second telephone is busy.

In the state that both the VoIP line and the PSTN line are set to the busy mode, the VoIP terminal monitors a hook state of the first and second telephones (S406) while checking whether or not a hook flash signal is received from the second telephone (S407).

As a result, when the hook flash signal is received from the second telephone, the first telephone which is currently performing a VoIP call is switched to a waiting call, and a VoIP call II is connected between the second telephone and the third telephone which is set to a waiting call, so that a VoIP call is performed between the second telephone and the third telephone (S408).

However, when the hook flash signal is not received from the second telephone at the step S407, it is checked whether or not the first telephone is hooked on (S409).

When the first telephone is hooked on, the VoIP terminal connects a VoIP call between the second telephone and the third telephone which is set to the waiting call to carry out the VoIP call between the second and third telephones (S413).

Also, when the second telephone or the third telephone is hooked on while the VoIP call is performed between the second telephone and the third telephone (S414), the VoIP terminal terminates a VoIP call session between the two telephones to thereby terminate the VoIP call (S415).

Meanwhile, if the first telephone is not hooked on at the step S409, the VoIP terminal checks whether or not the second telephone is hooked on (S410). If the second telephone is hooked on, the VoIP terminal terminates the VoIP call with the first telephone which is currently busy and provides the second telephone with a ring signal (S411).

If a hook off signal is not received from the second telephone in which the ring signal is being generated during a predetermined time period, a voice message that a user of the second telephone does not answer is forwarded to the third telephone which is set to the waiting call or the VoIP call connection with the third telephone which is set to the waiting call is terminated.

However, if the second telephone in which the ring signal is being generated is hooked off (S412), the VoIP call is connected with the third telephone which is set to the waiting call, so that the VoIP call is performed between the second telephone and the third telephone (S413).

That is, in the first embodiment of the present invention, when a VoIP incoming signal for the second telephone is received from the third telephone in the state that the VoIP call is carried out between the first and second telephones, the VoIP terminal provides the second telephone with a waiting tone to inform a user of the second telephone of the fact that a new incoming call is received and sets the third telephone to the waiting call, thereby guaranteeing two VoIP calls to a user.

In the first embodiment of the present invention, only two waiting calls are guaranteed, but two or more VoIP waiting calls can be guaranteed by setting two or more waiting calls and setting a priority order of the waiting calls according to a received time of incoming calls. Here, if a plurality of waiting calls are set, since a user of an originating telephone which originates a VoIP incoming call may wait for a long time, it is preferred to restrict the number of waiting calls.

Also, if a plurality of VoIP incoming calls are received, different waiting tone signals can be provided to the user, and thus the user can be easily informed the number of incoming calls which are set to a waiting call.

### Second Embodiment

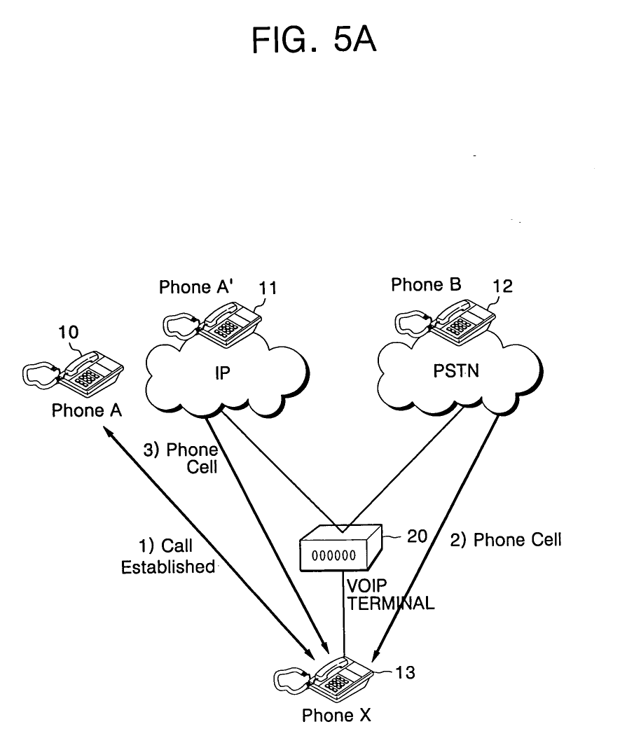

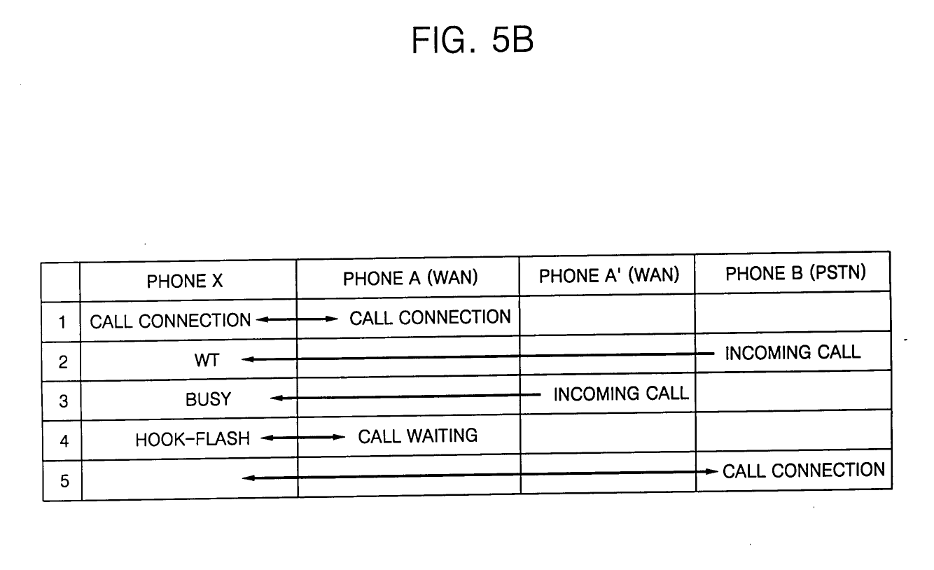

FIG. 5a is a view illustrating a call processing connection for a call waiting service when a PSTN incoming call is received from another telephone in the state that a VoIP call is busy in a VoIP terminal with a PSTN backup function according to a second embodiment of the present invention. FIG. 5b is a chart illustrating a call process for the call waiting service of FIG. 5a.

As shown in FIGS. 5a and 5b, in the state the VoIP call is busy, that is, a call between a telephone A 10 and a telephone X 13 is connected through a VoIP interface of a VoIP terminal 20, when an incoming call is received from a telephone B 12 connected to a PSTN network to the telephone X 13, the VoIP terminal 20 provides the receiving telephone X13 which is busy with a waiting tone “wt” for informing that a new PSTN incoming call is received. Moreover, then, the PSTN call received from the telephone B 12 is set to the waiting call.

In the state that two calls, i.e., a busy call and a waiting call are set, the VoIP terminal 20 sets the VoIP and PSTN lines to a busy mode in order not to receive any more incoming calls.

That is, when a new incoming call is received from a telephone A′ 11 through the VoIP line in the state that the busy call and waiting call are set, the VoIP terminal 20 provides the telephone A′ 11 with a busy tone signal or a busy message to inform a user of the telephone A′ 11 of the fact that the telephone X 13 is busy.

In this state, if a hook flash signal is generated from the telephone X which is currently busy, the VoIP terminal 20 switches a call with the telephone A 10 which is currently performing a VoIP call to a waiting call, and connects a VoIP call between the telephone X 13 and the telephone B 12 which is set to the waiting call to thereby perform the voice call therebetween.

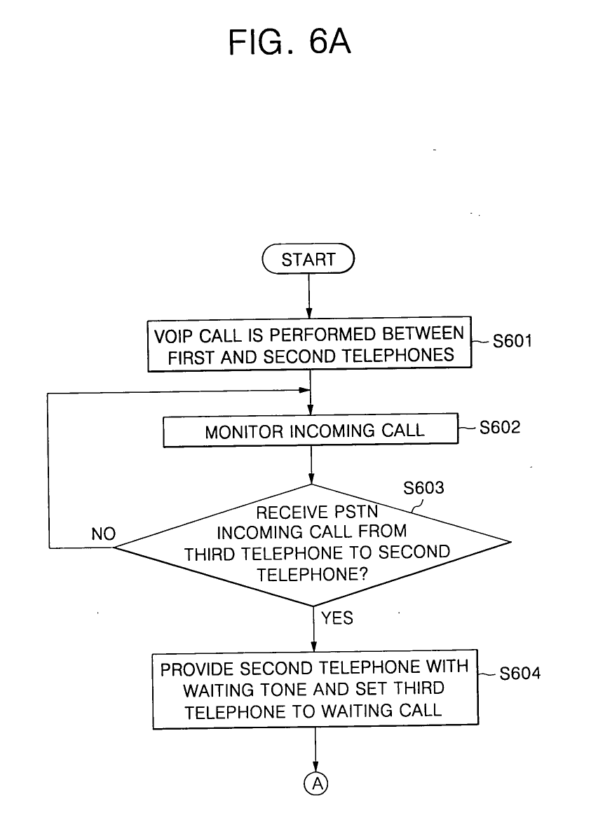

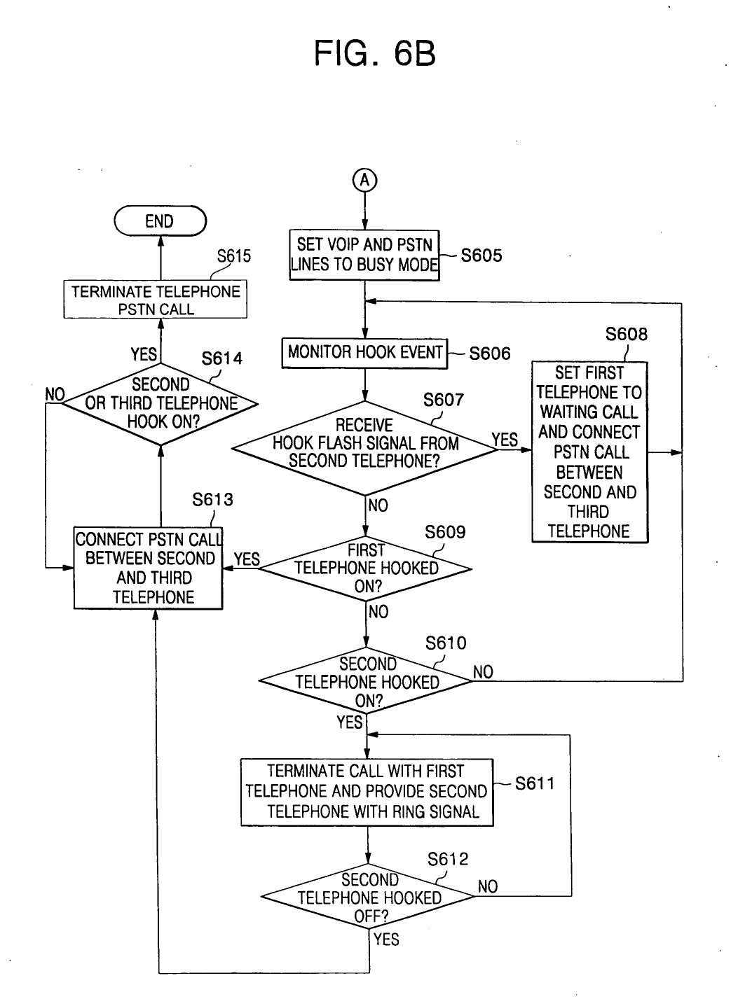

The call waiting service method when the PSTN call is received while a VoIP call is performed according to a second embodiment of the present invention will be explained in more detail with reference to FIGS. 6a and 6b.

FIGS. 6a and 6b are flow charts illustrating a call waiting service method when a PSTN call is received while a VoIP call is performed in the VoIP terminal with a PSTN backup function according to a second embodiment of the present invention.

As shown in FIGS. 6a and 6b, in the state that a VoIP call is performed between the first telephone (originating telephone) and the second telephone (receiving telephone) (S601), the VoIP terminal monitors a new PSTN or VoIP incoming call (S602).

If a PSTN incoming call is received from a third telephone to the second telephone which is currently busy (S603), the VoIP terminal generates a PSTN waiting tone “wt” to the second telephone to inform a user of the second telephone of the fact that a new PSTN incoming call is received, and sets the new PSTN incoming call from the third telephone to a waiting call (S604).

In the state that two calls, i.e., a busy call and a waiting call, are set, the VoIP terminal sets the VoIP line and the PSTN line to a busy mode (S605).

That is, when an incoming call is received from the other telephone in the state that two calls are already set in the VoIP terminal, the VoIP line and the PSTN line are set to a busy mode to provide the corresponding telephone with a busy tone for informing a user of the telephone which originates the incoming call of the fact that the second telephone is busy.

In the state that both the VoIP line and the PSTN line are set to the busy mode, the VoIP terminal monitors a hook state of the first and second telephones (S606) while checking whether or not a hook flash signal is received from the second telephone (S607).

As a result, when the hook flash signal is received from the second telephone, the first telephone which is currently performing a VoIP call is switched to the waiting call, and a PSTN call is connected between the second telephone and the third telephone which is set to a waiting call, so that a PSTN voice call is performed between the second telephone and the third telephone (S608).

However, when the hook flash signal is not received from the second telephone at the step S607, it is checked whether or not the first telephone is hooked on (S609).

When the first telephone is hooked on, the VoIP terminal connects a PSTN call between the second telephone and the third telephone which is set to the waiting call to carry out the PSTN voice call between the second and third telephones (S613).

Also, when the second telephone or the third telephone is hooked on while the PSTN voice call is performed between the second telephone and the third telephone (S614), the VoIP terminal terminates a call session between the two telephones to thereby terminate the PSTN call (S615).

Meanwhile, if the first telephone is not hooked on at the step S609, the VoIP terminal checks whether or not the second telephone is hooked on (S610). If the second telephone is hooked on, the VoIP terminal terminates a VoIP call with the first telephone which is currently busy and provides the second telephone with a ring signal (S611).

If a hook off signal is not received from the second telephone in which the ring signal is being generated during a predetermined time period, a voice message that a user of the second telephone does not answer is forwarded to the third telephone which is set to the waiting call or the PSTN call connection with the third telephone which is set to the waiting call is terminated.

However, if the second telephone in which the ring signal is being generated is hooked off (S612), the PSTN call is connected with the third telephone which is set to the waiting call, so that a PSTN voice call is performed between the second telephone and the third telephone (S613).

That is, in the second embodiment of the present invention, when a PSTN incoming signal for the second telephone is received from the third telephone in the state that a VoIP call is carried out between the first and second telephones, the VoIP terminal provides the second telephone with a waiting tone to inform a user of the second telephone of the fact that a new PSTN incoming call is received and sets the third telephone to a waiting call, thereby guaranteeing two calls to the user.

In the second embodiment of the present invention, two waiting calls are guaranteed, but two or more VoIP or PSTN waiting calls can be guaranteed by setting two or more waiting calls and setting a priority order of the waiting calls according to a received time of incoming calls. Here, if a plurality of waiting calls are set, since a user of an originating telephone which originates a VoIP incoming call may wait for a long time, it is preferred to restrict the number of waiting calls.

Also, if a plurality of VoIP or PSTN incoming calls are received, different waiting tone signals can be provided to a user, and thus the user can be easily informed the number of incoming calls which are set to a waiting call.

### Third Embodiment

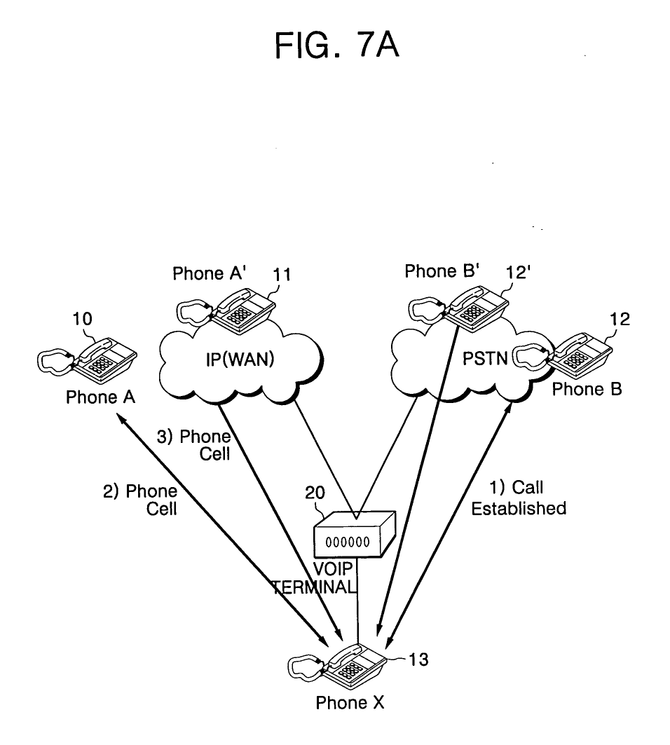

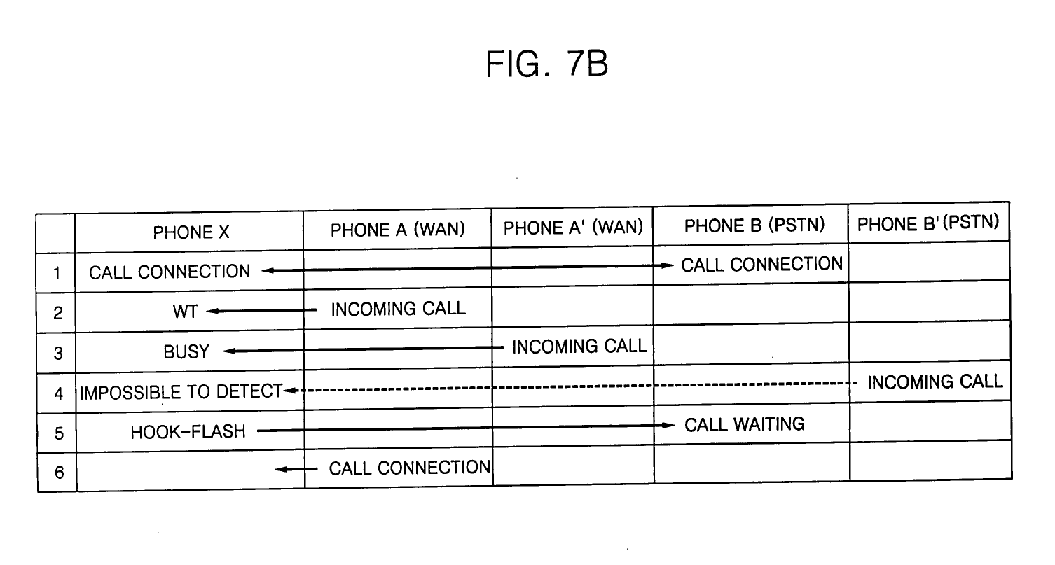

FIG. 7a is a view illustrating a call waiting service when a VoIP incoming call is received from another telephone in the state that a PSTN call is busy in a VoIP terminal with a PSTN backup function according to a third embodiment of the present invention. FIG. 7b is a chart illustrating a call processing connection for the call waiting service of FIG. 7a.

As shown in FIGS. 7a and 7b, in the state the PSTN call is busy, that is, a call between a telephone B 12 and a telephone X 13 is connected through the PSTN line interface of the VoIP terminal 20, when a VoIP incoming call is received from a telephone A 10 connected to an IP network to the telephone X 13, the VoIP terminal 20 provides the receiving telephone X13 which is busy with a waiting tone “wt” for informing that a new VoIP incoming call is received.

In the state that two calls, i.e., a busy call and a waiting call are set, the VoIP terminal 20 sets the VoIP and PSTN lines to a busy mode in order not to receive any more incoming call.

That is, when an incoming call is received from a telephone A′ 11 through the VoIP line interface in the state that a busy call and a waiting call are set, the VoIP terminal 20 provides the telephone A′ 11 with a busy tone signal or a busy message to inform a user of the originating telephone A′ 11 of the fact that the telephone X 13 is busy.

In this state, if a PSTN incoming call is received from a telephone B′ 12, the VoIP terminal 20 does not sense this. That is, for the VoIP terminal 20, it is difficult to sense an additional PSTN incoming call originated from the telephone B′ 12. This is because the VoIP call is managed by the VoIP terminal 20 whereas a PSTN call is managed by a PSTN switch in a telephone office.

That is, a first PSTN call is detected by using a voltage of a ring signal, but a second PSTN call is an analogue PSTN call waiting signal transmitted from the PSTN switch, and thus it is difficult for the VoIP terminal 20 to sense this.

The second PSTN call can be detected by a signal analysis of a DSP module (not shown) of the VoIP terminal 20, but this requires a high technical skill. For example, if a noise similar to a PSTN waiting call signal occurs, the VoIP terminal 20 is impossible to determine. Of course, if a second call (2) and a third call (3) of FIG. 7b do not occur, a fourth call (4) of FIG. 7b can be guaranteed by a PSTN waiting call service provided by the PSTN switch without control of the VoIP terminal 20.

Meanwhile, if a hook flash signal is generated from the receiving telephone X 13 which is currently busy, the VoIP terminal 20 switches a call with the telephone B 12 which is currently performing a PSTN call to a waiting call, and connects a VoIP call between the telephone X 13 and II the telephone A 10 which is set to the waiting call to thereby perform a voice call therebetween.

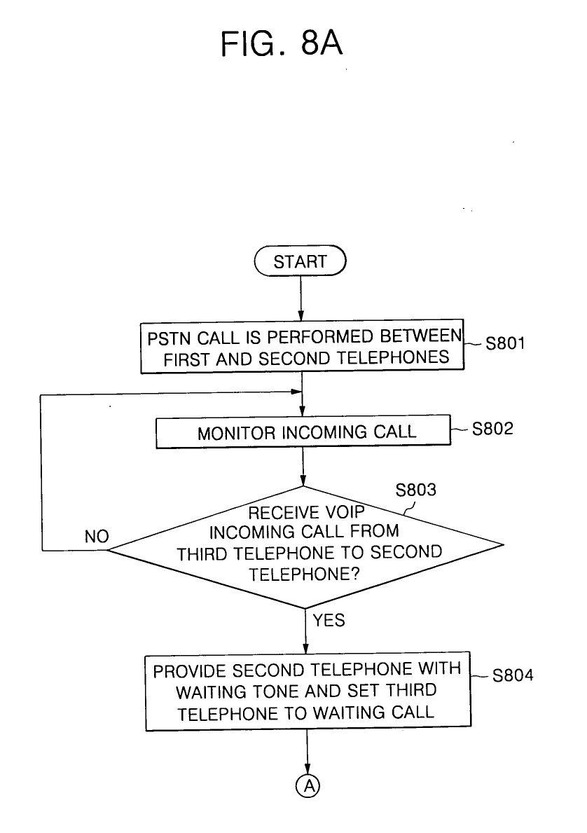

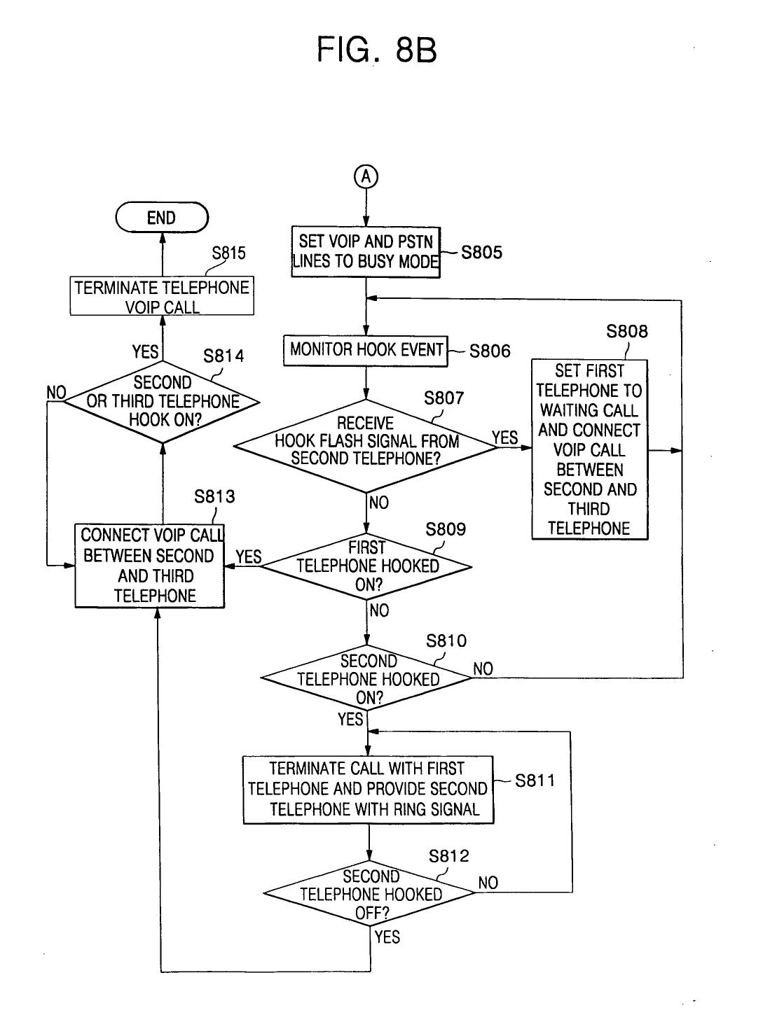

The call waiting service method when the VoIP call is received while a PSTN call is performed according to the third embodiment of the present invention will be explained in more detail with reference FIGS. 8a and 8b.

FIGS. 8a and 8b are flow charts illustrating a call waiting service method when a VoIP call is received while a PSTN call is performed in a VoIP terminal with a PSTN backup function according to a third embodiment of the present invention.

As shown in FIGS. 8a and 8b, in the state that the PSTN call is performed between a first telephone (originating telephone) and a second telephone (receiving telephone) (S801), the VoIP terminal monitors a new PSTN or VoIP incoming call (S802).

If a VoIP incoming call is received from a third telephone to the second telephone which is currently busy (S803), the VoIP terminal generates a VoIP waiting tone “wt” to the second telephone to inform a user of the second telephone of the fact that a new VoIP incoming call is received, and sets the new VoIP incoming call from the third telephone to a waiting call (S804).

In the state that two calls, i.e., a busy call and a waiting call, are set, the VoIP terminal sets the VoIP line and the PSTN line to a busy mode (S805).

That is, when a PSTN or VoIP incoming call is received from the other telephone in the state that two calls are already set in the VoIP terminal, both the VoIP line and the PSTN line are set to a busy mode to provide the corresponding telephone with a busy tone for informing a user of the telephone which originates the incoming call of the fact that the second telephone is busy.

In the state that both the VoIP line and the PSTN line are set to the busy mode, when a PSTN incoming call is received from a new telephone, it is difficult for the VoIP terminal to detect the new PSTN incoming call. This is explained above in detail in FIGS. 7a and 7b, and thus description on this is omitted. That is, the new PSTN call is difficult to detect but can be detected by a DSP module of the VoIP terminal to provide the telephone which originates the new PSTN incoming call with the busy tone signal.

Also, in the state that two calls are set, when a plurality of VoIP incoming calls are received, at least two waiting calls can be guaranteed at the same time by setting a priority order according to a received time of the plurality of VoIP incoming calls. If a plurality of waiting calls are set, since a user of an originating telephone which originates the VoIP incoming call may wait for a long time, it is preferred to restrict the number of waiting calls.

Also, if a plurality of VoIP or PSTN incoming calls are received, different waiting tone signals can be provided to a user, and thus the user can be easily informed the number of incoming calls which are set to a waiting call.

In the state that two calls are set and the VoIP line and the PSTN line are set to a busy mode like the step S805, the VoIP terminal monitors a hook state of the first and second telephones (S806) while checking whether or not a hook flash signal is received from the second telephone (S807).

As a result, when the hook flash signal is received from the second telephone, the first telephone which is currently performing a PSTN call is switched to a waiting call, and a VoIP call is connected between the second telephone and the third telephone which is set to a waiting call, so that a VoIP voice call is performed between the second telephone and the third telephone (S808).

However, when the hook flash signal is not received from the second telephone at the step S807, it is checked whether or not the first telephone is hooked on (S809).

When the first telephone is hooked on, the VoIP terminal connects the VoIP call between the second telephone and the third telephone which is set to the waiting call to carry out the VoIP call between the second and third telephones (S813).

Also, when the second telephone or the third telephone is hooked on while the VoIP call is performed between the second telephone and the third telephone (S814), the VoIP terminal terminates a VoIP call session between the two telephones to thereby terminate a VoIP call (S815).

Meanwhile, if the first telephone is not hooked on at the step S809, the VoIP terminal checks whether or not the second telephone is hooked on (S810). If the second telephone is hooked on, the VoIP terminal terminates a PSTN call with the first telephone which is currently busy and provides the second telephone with a ring signal (S811).

If a hook off signal is not received from the second telephone in which the ring signal is being generated during a predetermined time period, a voice message that a user of the second telephone does not answer is forwarded to the third telephone which is set to a waiting call or a VoIP cail connection with the third telephone which is set to the waiting call is terminated.

However, if the second telephone in which the ring signal is being generated is hooked off (S812), the VoIP call is connected with the third telephone which is set to the waiting call, so that the VoIP call is performed between the second telephone and the third telephone (S813).

That is, in the third embodiment of the present invention, when a VoIP incoming signal for the second telephone is received from the third telephone in the state that a PSTN call is carried out between the first and second telephones, the VoIP terminal provides the second telephone with a waiting tone to inform a user of the second telephone of the fact that a new incoming call is received and sets the third telephone to the waiting call, thereby guaranteeing at least two VoIP calls to the user.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

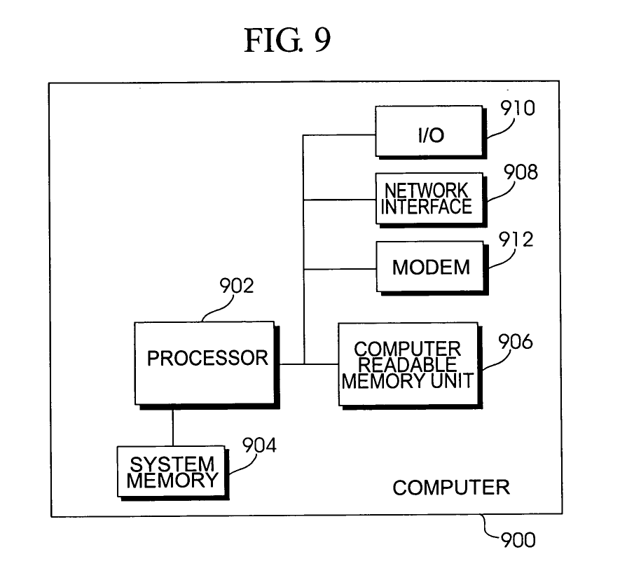

An example of a computer, but not limited to this example of the computer, that can read computer readable media that includes computer-executable instructions of the present invention is shown in FIG. 9. The computer 900 includes a processor 902 that controls the computer 900. The processor 902 uses the system memory 904 and a computer readable memory device 906 that includes certain computer readable recording media. A system bus connects the processor 902 to a network interface 908, modem 912 or other interface that accommodates a connection to another computer or network such as the Internet. The system bus may also include an input and output interface 910 that accommodates connection to a variety of other devices.

As described hereinbefore, the call waiting service method and apparatus in the VoIP terminal with the PSTN backup function according to the present invention can guarantee at least two VoIP or PSTN calls to a user by providing the second telephone with a waiting tone to inform a user of the second telephone of the fact that a new incoming call is received and setting the third telephone to a waiting call when a VoIP incoming call is received from the third telephone to the second telephone while a VoIP call is performed between the first and second telephones, when a PSTN incoming call is received from the third telephone to the second telephone while a VoIP call is performed between the first and second telephones, and when a VoIP incoming call is received from the third telephone to the second telephone while a PSTN call is performed between the first and second telephones.

Consequently, the conventional VoIP terminal with the PSTN backup function separately performs the VoIP call waiting service and the PSTN call waiting service, whereas the VoIP terminal with the PSTN backup function of the present invention incorporates the VoIP and PSTN call waiting services, and thus a PSTN incoming call can be guaranteed while a VoIP call is performed, and a VoIP incoming can be guaranteed while a PSTN call is performed.

As mentioned above, while the invention has been particularly shown and described with reference to the preferred embodiments thereof, it will be understood by those skilled in the art that the foregoing and other changes in form and details may be made therein without departing from the spirit and scope of the invention.

1. A call switching service method between terminals through a network, comprising:
when an incoming call is received from a third terminal to a second terminal through a first network or a second network while a call is performed between a first terminal and said second terminal through said first network, providing said second terminal with a waiting call generating signal and setting the incoming call originated from said third terminal to a waiting call; and
when a waiting call switching signal is received from said second terminal which is busy, switching said first terminal which is busy to a waiting call, and connecting a call between said second terminal and said third terminal which is set to the waiting call.

2. A call switching service method of a voice over Internet protocol terminal with a public switched telephone network backup function, comprising:
when a voice over Internet protocol or public switched telephone network incoming call is received from a third telephone to a second telephone while a voice over Internet protocol call is performed between a first telephone and said second telephone, providing said second telephone with a voice over Internet protocol or public switched telephone network waiting call generating signal and setting the incoming call from said third telephone to a waiting call;
after the incoming call from said third telephone is set to the waiting call, setting a voice over Internet protocol line and a public switched telephone network line which are connected to said voice over Internet protocol terminal to a busy mode; and
when a hook flash signal is received from said second telephone which is busy, switching said first telephone which is busy to a waiting call, and connecting a voice over Internet protocol or public switched telephone network call between said second telephone and said third telephone which is set to the waiting call.

3. The method of claim 2, wherein the waiting call generating signal includes at least one of a tone signal and a waiting call generating voice message.

4. The method of claim 2, wherein at the step of setting the incoming call from said third telephone to the waiting call, when said public switched telephone network or voice over Internet protocol incoming call is received from at least one telephone, a priority order is conferred to the incoming calls from the telephones according to a received time of the incoming calls before the sequential incoming calls of the telephones are set to the waiting calls.

5. The method of claim 2, further comprising,
in the state that the incoming call from said third telephone is set to the waiting call,
when a hook on signal is received from said second telephone which is busy, terminating a call connection with said first telephone and transmitting to said second telephone a ring signal for requesting a voice over Internet protocol call to be switched to said third telephone which is currently set to the waiting call; and
when a hook off signal is received from said second telephone, connecting a call between said second telephone and said third telephone which is set to the waiting call.

6. A call switching service method of a voice over Internet Protocol terminal with a public switched telephone network backup function, comprising:
when a voice over Internet protocol incoming call is received from a third telephone to a second telephone while a public switched telephone network call is performed between a first telephone and said second telephone, providing said second telephone with a voice over Internet protocol waiting call generating signal and setting the voice over Internet protocol incoming call from said third telephone to a waiting call;
after setting the incoming call from said third telephone to the waiting call, setting a voice over Internet protocol line and a public switched telephone network line which are connected to said voice over Internet protocol terminal to a busy mode; and
when a hook flash signal is received from said second telephone which is busy, switching said first telephone which is busy to a waiting call, and connecting a voice over Internet protocol call between said second telephone and said third telephone which is set to the waiting call.

7. The method of claim 6, wherein the waiting call generating signal includes at least one of a tone signal and a waiting call generating voice message.

8. The method of claim 6, further comprising,
in the state that the voice over Internet protocol incoming call from said third telephone is set to the waiting call,
when a hook on signal is received from said second telephone which is busy, terminating a call connection with said first telephone and transmitting to said second telephone a ring signal for requesting a voice over Internet protocol call to be switched to said third telephone which is currently set to the waiting call; and
when a hook off signal is received from said second telephone, connecting a voice over Internet protocol call between said second telephone and said third telephone which is set to the waiting call.

9. A call switching system between terminals through at least one different network, comprising:
a waiting call processor for providing a second terminal with a waiting call generating signal and setting an incoming call originated from a third terminal to a waiting call when said incoming call is received from said third terminal to said second terminal through a first network interface or a second network interface while a call is performed between a first terminal and said second terminal through said first network interface; and
a call switching processor for switching said first terminal which is busy to a waiting call, and connecting a call between said second terminal and said third terminal which is set to said waiting call when a waiting call switching signal is received from said second terminal which is busy.

10. The system of claim 9, wherein said waiting call generating signal provided from said waiting call processor to said second terminal includes at least one of a tone signal and a waiting call generating voice message.

11. The system of claim 9, wherein in the state that said incoming call from said third terminal is set to said waiting call, when incoming calls are received from a plurality of terminals through said first network interface or said second network interface, said waiting call processor confers a priority order to said incoming calls according to a received time of said incoming calls and sets said sequential incoming calls to said waiting calls.

12. The system of claim 9, wherein in said state that said incoming call from said third terminal is set to a waiting call, said call switching processor:
transmits to said second terminal a call switching request signal for requesting a call to be switched to said third terminal which is currently set to said waiting call when a call connection-terminating signal with said first terminal is received from said second terminal which is busy; and
connects a call between said second terminal and said third terminal which is set to said waiting call when a response signal for said call switching request signal is received from said second terminal.

13. The system of claim 12, wherein said call connection-terminating signal is a hook on signal, said call switching request signal is a ring signal, and said response signal for said call switching request signal is a hook off signal.

14. A call switching service system of a voice over Internet Protocol terminal with a public switched telephone network backup function and having a voice over Internet protocol line interface and a public switched telephone network line interface, comprising:
a first incoming call processor for providing a second telephone with a voice over Internet protocol or public switched telephone network waiting call generating signal and setting a voice over Internet protocol or public switched telephone network incoming call from a third telephone to a waiting call when said voice over Internet protocol or public switched telephone network incoming call is received from said third telephone to said second telephone through said voice over Internet protocol line interface or said public switched telephone network line interface while a voice over Internet protocol or public switched telephone network call is performed between a first telephone and said second telephone;
a second incoming call processor for setting said voice over Internet protocol or public switched telephone network line interface to a busy mode after said first incoming call processor sets said incoming call from said third telephone to said waiting call; and
a call switching processor for setting said first telephone which is busy to a waiting call and connecting said voice over Internet protocol or public switched telephone network call between said second telephone and said third telephone which is set to said waiting call by said first call processor when a hook flash signal is received from said second telephone which is busy.

15. The system of claim 14, wherein when incoming calls are received from at least one telephone through said voice over Internet protocol line interface or said public switched telephone network line interface, said first incoming call processor confers a priority order to said incoming calls according to a received time of said incoming calls and sets said sequential incoming calls to said waiting calls.

16. A method, comprising:
performing a voice over Internet protocol call between a first telephone and a second telephone while the voice over Internet protocol terminal monitors a new telephone network or voice over Internet protocol incoming call;
when a voice over Internet protocol incoming call or a telephone network incoming call is received from a third telephone to said second telephone which is currently busy, generating by the voice over Internet protocol terminal, a corresponding voice over Internet protocol or telephone network waiting tone to said second telephone to inform a user of said second telephone of an information that a new voice over Internet protocol incoming call or new telephone network incoming call is received, and setting the new voice over Internet protocol or telephone network incoming call from said third telephone to a waiting call;
when two calls are set, setting, by the voice over Internet protocol terminal, the voice over Internet protocol line and the telephone network line to a busy mode to provide the corresponding telephone with a busy tone for informing a user of the telephone which generates an incoming call of the information that the second telephone is busy; and
when both the voice over Internet protocol line and the telephone network line are set to the busy mode, monitoring by said voice over Internet protocol terminal, a hook state of the first and second telephones while checking whether or not a hook flash signal is received from the second telephone.

17. The method of claim 16, further comprising of:
when the hook flash signal is received from said second telephone, switching, said first telephone which is currently performing a voice over Internet protocol call, to a waiting call, and a voice over Internet protocol call or telephone network call is connected between the second telephone and the third telephone which is set to a waiting call, accommodating a voice over Internet protocol call or telephone network being performed between the second telephone and the third telephone.

18. The method of claim 16, further comprising of:
when the hook flash signal is not received from the second telephone, determining, by the hook flash, whether or not the first telephone is hooked on.

19. The method of claim 18, further comprising of:
when the first telephone is not hooked on, checking, by the voice over Internet protocol terminal, whether or not the second telephone is hooked on; and
when the second telephone is hooked on, terminating by the voice over Internet protocol terminal, the voice over Internet protocol or telephone network call with the first telephone which is currently busy and provides the second telephone with a ring signal.

20. The method of claim 18, further comprising of:
when a hook off signal is not received from the second telephone in which the ring signal is being generated during a predetermined time period, forwarding a voice message that a user of the second telephone does not answer to the third telephone which is set to the waiting call or the voice over Internet protocol or telephone network call connection with the third telephone which is set to the waiting call is terminated.

21. The method of claim 16, further comprising of:
when a voice over Internet protocol or telephone network incoming signal for the second telephone is received from the third telephone in the state that the voice over Internet protocol or telephone network call is carried out between the first and second telephones, providing, by the voice over Internet protocol terminal, the second telephone with a waiting tone to inform a user of the second telephone of the information that a new voice over Internet protocol or telephone network incoming call is received and sets the third telephone to the waiting call, accommodating a guaranteeing of at least two calls to a user.
